(19) United States
(12) Patent Application Publication
(10) Pub. No.: US 2022/0270280 A1
(43) Pub. Date: Aug. 25, 2022

(54) SYSTEM AND TOOLS FOR DETERMINING RING SIZE

(71) Applicant: Dearest Technologies Ltd, London (GB)

(72) Inventors: Marie Angelyn Mercado, Quezon City (PH); Giuseppe Burdo, London (GB); Joseph Daryl Locsin, Makati (PH); Germee Ronirose Abesamis, Quezon City (PH); Andrew Tan, Singapore (SG)

(73) Assignee: Dearest Technologies Ltd, London (GB)

(21) Appl. No.: 17/184,778

(22) Filed: Feb. 25, 2021

(51) Int. Cl. G06T 7/60

(52) U.S. Cl. CPC G06T 7/60; G06T 2207/30196; G06T 2207/30242

(57) ABSTRACT

The user apparatus includes a memory system, a processing system, a sensor system, and a user interface including at least one image display and an input user interface. In one example, the apparatus performs ring sizing on one or more fingers of a given human hand. The user apparatus may be an integrated device or separate devices. It may be a handheld smartphone, or a wearable smart device. In the case of a wearable smart device, it may include a watch or glasses. In one embodiment, the processing system is configured to cause a number of acts. At least one sensor in the sensor system is operated to sense at least a portion of the given hand and an adjacent reference object. The sensor system provides sensor spatial data in terms of the sensor. The spatial data includes hand spatial information locating portions of an outer surface of the given hand, and further includes reference object spatial information locating one or more measurable references on the reference object. Transformation processing is performed on at least some of the sensor spatial data in order to determine world spatial data in terms of real world positioning. The transformation processing includes using the reference object spatial information in the sensor spatial data. The processing system determines, from the world of spatial data, the diameter of the given finger on the given fingers profile at a ring position near where the given finger joins at least one adjacent non thumb finger. Based on the determined diameter value of the given finger, a determination is made of a ring size in the United States and Canadian system. The ring size is communicated to the user.

### FIELD OF THE DISCLOSURE

Aspects of the present disclosure relate to tools to help individuals measure their physical characteristics in order to determine a size of a wearable item, for example, a fashion accessory or apparel. One aspect relates to determining ring size. Certain aspects of the disclosure relate to one or more of: systems for measurement, automated decision making, machine vision, communication, and information access.

### BACKGROUND OF THE DISCLOSURE

People are increasingly using online and other remote communication methods to define or find wearable items tailored to their unique physical attributes. For example, tiffany.com provides a ring size chart and guide (at https://media.tiffany.com/is/content/Tiffany/Tiffany_Ring_Size_Guide) to help their online customers determine their ring size before making a remote online purchase. Nike has a Nike Fit digital foot measurement tool that uses a smartphone camera to scan a customer's feet, collecting data points mapping their foot morphology. The scan can be stored in a member profile and used for future in-store or online shopping.

### SUMMARY OF THE DISCLOSURE

An objective of the present disclosure may be to provide new tools that help individuals determine their own wearable item size, for example, ring size. For example, an app, a system, or a device guides and helps a user to easily and quickly capture their own physical characteristic data using a sensor and determine a wearable apparel size.

One or more alternate or additional objectives may be served by the present invention, for example, as may be apparent by the following description. Embodiments of the disclosure include any apparatus, machine, system, method, articles (e.g., computer-readable media), or any one or more subparts or subcombinations of such apparatus (singular or plural), system, method, or article, for example, as supported by the present disclosure. Embodiments herein also contemplate that any one or more processes as described herein may be incorporated into a processing circuit.

One embodiment of the present disclosure is directed to apparatus that includes user apparatus. The user apparatus includes a memory system, a processing system, a sensor system, and a user interface including at least one image display and an input user interface. In one example, the apparatus performs ring sizing on one or more fingers of a given human hand. The user apparatus may be an integrated device or separate devices. It may be a handheld smartphone, or a wearable smart device. In the case of a wearable smart device, it may include a watch or glasses.

In one embodiment, the processing system is configured to cause a number of acts. At least one sensor in the sensor system is operated to sense at least a portion of the given hand and an adjacent reference object, The sensor system provides sensor spatial data in terms of the sensor. The spatial data includes hand spatial information locating portions of an outer surface of the given hand, and further includes reference object spatial information locating one or more measurable references on the reference object.

Transformation processing is performed on at least some of the sensor spatial data in order to determine world spatial data in terms of real world positioning. The transformation processing includes using the reference object spatial information in the sensor spatial data. The processing system determines, from the world of spatial data, the diameter of the given finger on the given fingers profile at a ring position near where the given finger joins at least one adjacent non thumb finger. Based on the determined diameter value of the given finger, a determination is made of a ring size in the United States and Canadian system. The ring size is communicated to the user.

### DESCRIPTION OF THE DRAWINGS

Example embodiments will be described with reference to the following drawings, in which:

FIG. 1 is a block diagram of a communications system;

FIG. 2 is a simplified image of a display showing a captured image of a hand and a credit card serving as a reference object, with guide markings added;

FIG. 3 is a flow chart of a server side process for determining ring size from one or more captured images;

FIG. 4 is a flow chart of a user apparatus process for determining ring size;

FIG. 5 is a flow chart of an embodiment of card size processing;

FIG. 6 is a flow chart of an embodiment of error handling processing; and

FIG. 7 is a flow chart of an embodiment of a finger diameter process.

### DETAILED DESCRIPTION

In accordance with one or more embodiments herein, various terms may be defined as follows.

Application program. An application program is a program that, when executed, involves user interaction, whereas an operating system program, when executed, serves as an interface between an application program and underlying hardware of a computer.

Lidar (light detection and ranging). Lidar is a method for measuring distances by illuminating the target with laser light and measuring the reflection with a sensor.

Processing circuit. A processing circuit may include both (at least a portion of) computer-readable media carrying functional encoded data and components of an operable computer. The operable computer is capable of executing (or is already executing) the functional encoded data, and thereby is configured when operable to cause certain acts to occur. A processing circuit may also include: a machine or part of a machine that is specially configured to carry out a process, for example, any process described herein; or a special purpose computer or a part of a special purpose computer. A processing circuit may also be in the form of a general purpose computer running a compiled, interpretable, or compliable program (or part of such a program) that is combined with hardware carrying out a process or a set of processes. A processing circuit may further be implemented in the form of an application specific integrated circuit (ASIC), part of an ASIC, or a group of ASICs. A processing circuit may further include an electronic circuit or part of an electronic circuit. A processing circuit does not exist in the form of code per se, software per se, instructions per se, mental thoughts alone, or processes that are carried out manually by a person without any involvement of a machine.

Profile. An outline of something, for example, a person's face, as seen from one side.

Program. A program includes software of a processing circuit.

Sensor. A device which detects or measures a physical property and records or otherwise responds to the physical property. Imaging sensors include passive imaging sensors and active Imaging sensors. A passive Imaging sensor uses ambient light to image a scene. For example, a camera with a lens and a two-dimensional sensor is a type of passive Imaging sensor. An active imaging sensor controls the light source and uses triangulation or time of flight. Lidar is a type of active Imaging.

User interface tools; user interface elements; output user interface; input user interface; input/output user interface; and graphical user interface tools. User interface tools are human user interface elements which allow human user and machine interaction, whereby a machine communicates to a human (output user interface tools), a human inputs data, a command, or a signal to a machine (input user interface tools), or a machine communicates, to a human, information indicating what the human may input, and the human inputs to the machine (input/output user interface tools). Graphical user interface tools (graphical tools) include graphical input user interface tools (graphical input tools), graphical output user interface tools (graphical output tools), and/or graphical input/output user interface tools (graphical input/output tools). A graphical input tool is a portion of a graphical screen device (e.g., a display and circuitry driving the display) configured to, via an on-screen interface (e.g., with a touchscreen sensor, with keys of a keypad, a keyboard, etc., and/or with a screen pointer element controllable with a mouse, toggle, or wheel), visually communicate to a user data to be input and to visually and interactively communicate to the user the device's receipt of the input data. A graphical output tool is a portion of a device configured to, via an on-screen interface, visually communicate to a user information output by a device or application. A graphical input/output tool acts as both a graphical input tool and a graphical output tool. A graphical input and/or output tool may include, for example, screen displayed icons, buttons, forms, or fields.

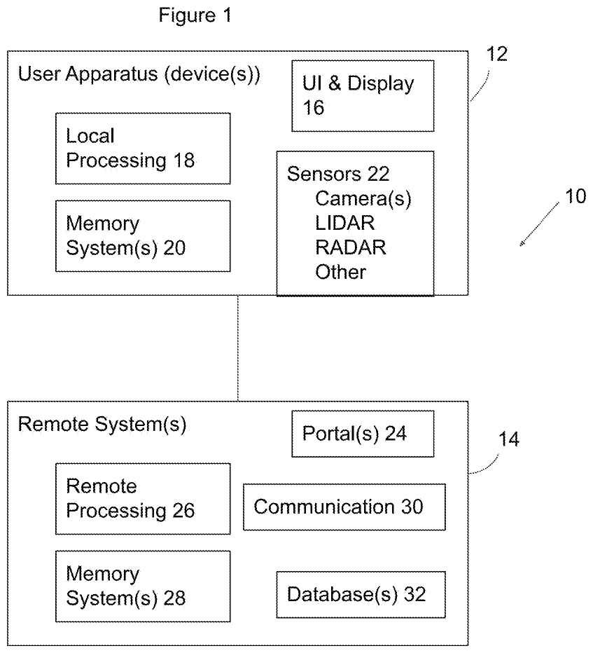

Referring now to the drawings in greater detail, FIG. 1 shows a communication system which is used to help users configure, obtain, or purchase wearable items, for example, jewelry. The illustrated communication system 10 includes user apparatus 12 and server 14. User apparatus 12 includes local processing circuitry 18, one or more memory systems 20, a user interface and display 16, and one or more sensors 22. Remote system(s) 14 includes remote processing circuitry 26, one or more remote memory systems 28, one or more portals 24, communication engine 30, and one or more databases 32. In the illustrated embodiments, user interface and display 16 may be separate elements, a combination display/interface, or a mix where there is a user interface, and the display allows for input, output or both. User interface and display 16 may be used to implement user interface tools, user interface elements, an output user interface, an input user interface, an input/output user interface, and/or graphical user interface tools.

User apparatus 12 and server 14 may be connected to each other via any number of different communication mediums and methods. For example, user apparatus may be a smartphone connected to the Internet via a wifi connection, or via a network provider connection. In select embodiments, the Internet typically forms part of the connection between user apparatus 12 and server 14, which may be connected to the Internet with a broadband Internet or some other type of connection, e.g., a local or wide area network. In certain example embodiments, the communication between apparatus 12 and server 14 may be via one or more APIs (provided at either or both apparatus 12 and server), one or more apps (provided at either), or a web browser on apparatus 12 with corresponding web server functionality at server 14.

The user apparatus may be an integrated device, or separate devices. the device may be a handheld smartphone, or a wearable smart device, for example a watch or glasses. the memory system(s) 20 may include, for example, one or both of a combination of RAM, a cache, solid-state memory, or disk memory. The memory system(s) 20 may be a distributed type of memory system including memory components that are both local to user apparatus 12 and that are remote, connected via a local or wide area network. The memory system(s) 20 and local processing circuitry 18 may further include systems that are provided in a remote server or back-end system, or be a distributed system with portions in the local system 12 and in the remote server 14.

The sensor system 22 includes one or more sensors, including one or more cameras, a Lidar sensor, a radar sensor, and other types of sensors. Sensor system 22 may include a pixelized camera. The camera may be a 2d camera, or a 3D camera. The pixelized cameras may be plural, including two cameras, three cameras or more. A video camera may be provided that produces a sequence of images. A laser sensor may be provided, for example, Lidar. A miniature radar sensor (e.g.,a Soli chip by Google) may be provided. In addition, a MEMS sensor (not shown) may be provided. Sensors 22 may include front facing (in the direction of the display screen) and/or back facing sensors. In one embodiment, plural front facing cameras and plural back facing cameras are provided.

The processing performed by communication system 10, as described herein, may be carried out by local processing circuitry 18, by remote processing circuitry 26, or any combination of the two and/or other processors. Those processing portions may be implemented with processing circuitry and/or code. In accordance with one embodiment, an app may be provided which is stored in memory system(s) 20 and run with local processing circuitry 18. In addition, an API (application programming interface) may be provided for allowing remote systems to access functionality provided by the app. The app may control certain aspects of user apparatus 12 by communicating with an operating system of a particular device. For example, if user apparatus 12 is a smartphone, it may be an iPhone, in which case the operating system on the device would be the iOS system.

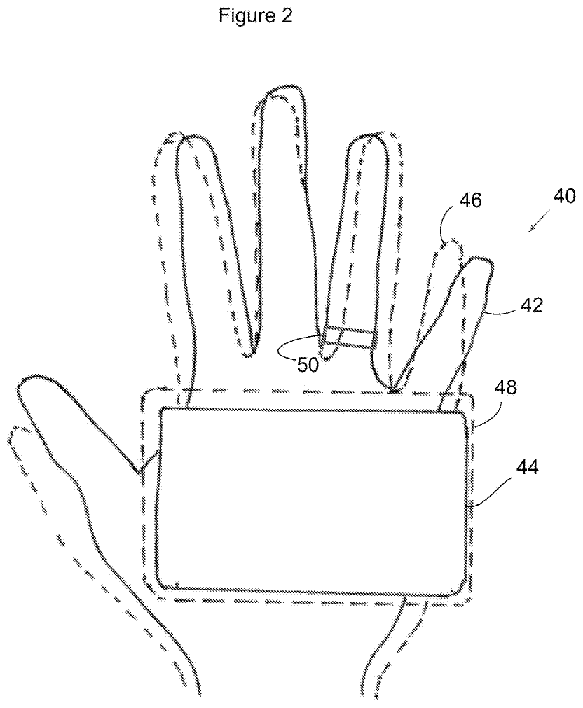

User interface and display 16 is configured with local processing circuitry 18 to cause a user to be prompted to put a reference object and a given hand to be sized into a field of view of one or more sensors 22. The embodiment Illustrated, referring to FIG. 2, a hand 42 is placed in the field of view of a camera. The camera in the Illustrated embodiment is a back facing camera. A body part (hand) outline 46 is provided on the screen of display. In addition, a reference object (credit card) outline 48 is provided. Outlines 46 and 48 serve as positioning guides for a body part to be sized (a hand in the illustrated embodiment) and a reference object (credit card in the Illustrated embodiment). In operation per one embodiment, once prompted by user interface and display 16, the user places their hand 42 holding a credit card 44 within the field of view of the camera, resulting in the capture and display of an image substantially as (schematically) shown in FIG. 2.

One or more remote systems 14 are provided. Each remote system, as Illustrated, includes one or more portals 24, a communication portion 30, one or more databases 32, remote processing circuitry 26, and one or more memory systems 28.

In the Illustrated embodiment, three or more cameras are provided which allow for three-dimensional image capture. In addition, a Lidar device may be provided. A Lidar device sends and detects returning light pulses, allowing for light detection and ranging. In one embodiment, an IR camera is provided such as the TrueDepth™ IR camera in the iPhone X. The IR emitter may be supplemented with an illuminator, and be configured to emit IR Dots in a prescribed pattern for different body parts to be sized. In one embodiment, the IR camera determines real world dimensions of a subject body part, which may be a user's head, neck, an individual foot, a pair of feet, an individual finger, a hand, or a pair of hands. This determination of real world dimensions can be used in addition to, or in lieu of, the use of a reference object of known dimensions, in order to allow a translation between the pixel (of voxel) space measurements of select points on the subject body part obtained by the camera(s) and the actual physical distance values for those same points. A depth sensor may have an API call for obtaining contour information in terms of real world coordinates. The depth and imagining sensors may be fused in order to provide a combined map showing contour and sensor spatial data in terms of world spatial data in world coordinates or some other coordinate system in which points of the given hand and the reference object are defined in terms of actual distances (e.g., in meters).

Such a sensor may be configured to provide a map of the contours of a subject hand, allowing for sizing of a selected finger, or another portion of the hand to be sized—to which a wearable item can be attached (e.g., wrist size).

In some embodiments, the system may be configured to determine a ring size (or other body part size) without the subject individual being made aware of the measurement. For example, an automatic motion or proximity sensor may be provided to sense the moment a smartphone is picked up, at which point the sensor(s)/camera(s) can be activated to capture contour information regarding the subject body part. Information may be included regarding the user's hand so that it can be associated with the identity of that user. In one embodiment, the user of the system can enter an individual's name in order to tag or associate sensed contour information regarding a given hand with that individual.

In the illustrated embodiments, it is expected that a standard credit card will be used, typically referred to as an ID-1 credit card with dimensions of 85.6 mm by 53.98 mm. In other embodiments, the reference object may be another object of known size. For example, a phone having a known size can be used as a reference object. The reference object can be a smartphone serving as user apparatus 12, or it may be another phone. If the reference object is the smartphone serving as user apparatus, a person holding the phone can image their own hand with the phone using a mirror. If the reference object is a different phone, the given hand is imaged with the different phone in a manner similar to that shown when the reference object is a credit card.

At specific times, code or processing circuitry forming part of communication system 10 may not be in an operable state. For example, power may not be provided to the device, code may not be instantiated, and so on.

In select embodiments, when the user is prompted to place a hand to be sized within the field of view of the sensor, prompting is via an audible output of the user interface, via a tactile output, and/or a visible output. In the event of a tactile output, a mechanism may be provided that allows a user to provide input and read output with their sense of touch. A braille-enabled interface may be provided, as an example.

Sensors 22 may be configured, when performing sizing, to sense all or just a portion of a subject's body part. In the illustrated embodiment, the body part to be sized is a hand, specifically one or more specified fingers on the hand. An input may be provided to allow a user to configure which portion of the subject's body is to be measured. In one embodiment, they would select a particular finger to be sized.

In the illustrated embodiments, the reference object is an object of known dimensions. Specifically, it may be a standard ID-1 credit card, as described above. Communications system 10 may be provided with a processing circuit configured to to check if an object sensed with the given hand is likely a standard credit card. This check may happen the moment that the wearable product sizing processing circuit determines that the given hand entered the sensor's field of view with the reference object. A determination if the object is likely a credit card may involve the use of a blob detector, and comparing the results of the blob detection to expected values.

When the wearable product sizing processing circuit determines that the reference object is likely a credit card, it may then be subjected to a blob detector that is invariant to affine transformations. An affine shape adaptation may be applied to a blob descriptor, where the shape of the smoothing kernel is iteratively warped to match the local image structure around the blob. Alternatively, a local image patch may be iteratively warped while the shape of the smoothing kernel remains rotationally symmetric. In one embodiment, the Apple Vision Framework may be used, and the rectangle detection request of that framework may be utilized. Portions of a credit card image may be cropped out and removed in order to provide identity and data protection. This may be done in a way so that that sensitive information on the card is never captured by communications system 10, and is never shown on the display.

The image processing engine of communication system 10 may be configured to use an affine transformation to transform from the camera view to a system showing the rectangle in a normalized coordinate system with the origin as the left lower corner of the screen. Then, rectangle detection may be performed.

In one embodiment, the image pertaining to the credit card is isolated from the rest of the image. If part of the card is hidden, those aspects of the image are restored. The reference object may also be a smartphone of known dimensions. In one embodiment, it may be an iPhone. An additional calculation may be provided to address when the smartphone has a casing changing its dimensions.

A confirmation is made as to whether a given finger of the hand to be sized and the reference object are substantially in the same plane and at substantially the same distance from the lens of the camera. Once this is done, further image processing may be performed in order to associate location information pertaining to the given finger with location information pertaining to the reference object.

The sensor system provides sensor spatial data. That data may include two dimensional data or three-dimensional data. The data may also include depth and contour data. This data is provided in terms of the sensor, e.g., in terms of the pixels or voxels. The sensor spatial data is provided automatically once the reference object and the given hand are sensed by one or more sensors, which may be the same or different sensors. When the processor determines that the reference object and the given hand are arranged and positioned correctly, the sensor spatial data may be provided. The sensor spatial data includes measurable references of the reference object, which may be one or more points or edges.

In one embodiment, the measurable references may include points or edges that define a diameter of at least one sensor on a side of a smartphone sensed along with the given hand. The world spatial data, determined once the transformation process occurs, may be in a given real world coordinate system.

The processing system determines from the world spatial data the diameter of the given finger. That diameter is the distance between at least two opposing points on the given finger's profile at a ring position near where the given finger joins at least one adjacent non-thumb finger. That distance between at least two opposing points in one embodiment is the maximum diameter of a perimeter of the finger cross-section.

Communication system 10 determines the ring size of the given finger, and that ring size is communicated to the user. In accordance with one embodiment, that happens by displaying the ring size on the image display 16. In addition, or alternatively, that information may be communicated to the user with a post to their account, or in a message which may be a text message or email. It is possible to determine the ring size information in camera space, for example, in terms of pixels, voxels, or some other unit, and then convert to a ring size or to a real-world distance value, for example, millimeters.

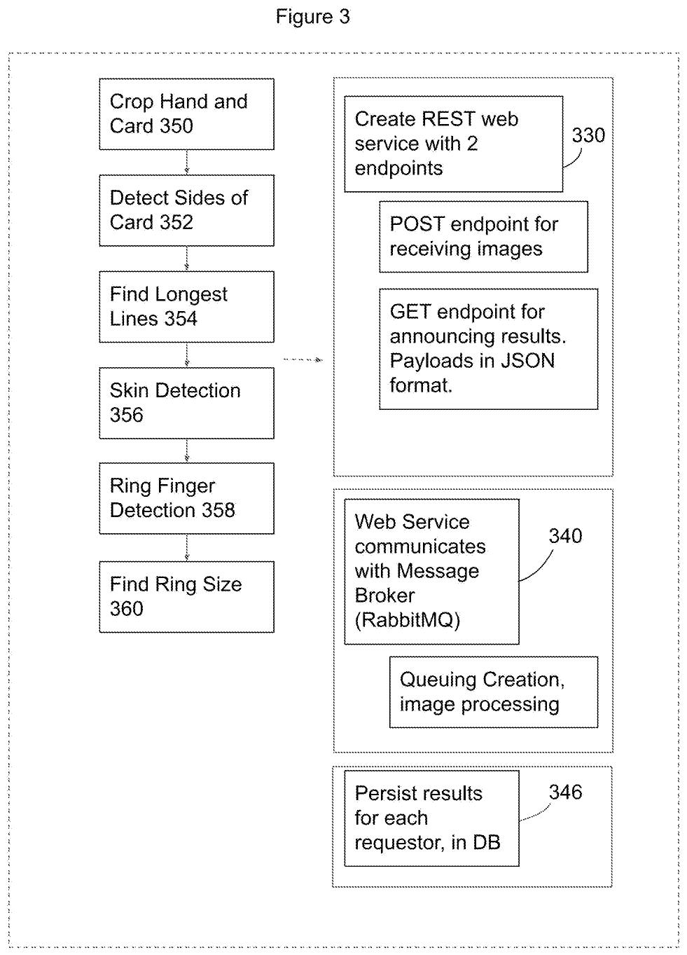

FIG. 3 shows a flow chart of a server-side process in accordance with one embodiment. The Illustrated process may be performed using a RESTful web service approach as Illustrated. This is indicated to the right side of FIG. 3, where at act 330, a REST web service is created with two endpoints. This is accompanied by a POST endpoint for receiving images and a GET endpoint for announcing results. Payloads are provided in a JSON format. As shown at act 340, the web service communicates with a message broker provided at the user apparatus. In the illustrated embodiment, the web message broker is a RabbitMQ message broker. Each message broker is queued, and is where image processing occurs. The results are persisted in the database at act 346.

In the illustrated embodiment, whenever a ring size determination is made using image processing, this occurs on the web server. An asynchronous task (for example, a Celery worker algorithm) is performed, as shown on the left side of FIG. 3. In act 350, the hand and card are cropped. Next, at act 352, the sides of the card are detected. In act 354, the longest lines of the card are found. In act 356, the skin portion of the image is detected in order to segment the image using binarization. This may be done, e.g., by performing skin color thresholding as described by Phillip Wagner at https://www.bytefish.de/blog/skin_color_thresholding.html. In a next act 358, the ring finger is detected. Once the ring finger is detected, in act 360, the ring size is determined.

Once the task for determining a ring size is completed at the server, it is returned to the client. The client deserializes the successful JSON payload, and extracts the ring size value in millimeters. The client then displays the ring size on the display of the user apparatus.

The ring size process depicted in FIG. 3 may be configured per another embodiment to involve the following acts. Initially or early in the process, one or more customers had provided images which were uploaded to the server. The ring size process may then take one of those images, in order to determine the ring size for that customer. A human operator may then take that image, and place a rectangular shape 50 over the ring finger base (or another finger depending on the one to be sized), as shown in FIG. 2. An automated process may also be provided to overlay such a rectangular shape 50 in the right location. The rectangle is adjusted to correspond to the outer edges of the finger, including changing the orientation angle of the rectangle so the rectangle sides are tangential to the outer edges of the finger.

A calculation may then be done to determine the length of the overlaid rectangle in image space (L_{R-I}), and also determine the length of the credit card in image space (L_{C-I}). Then, the finger diameter can be calculated using the following equation, solving for x:

(L_{R-I})/×=(L_{C-I})/85.6 mm

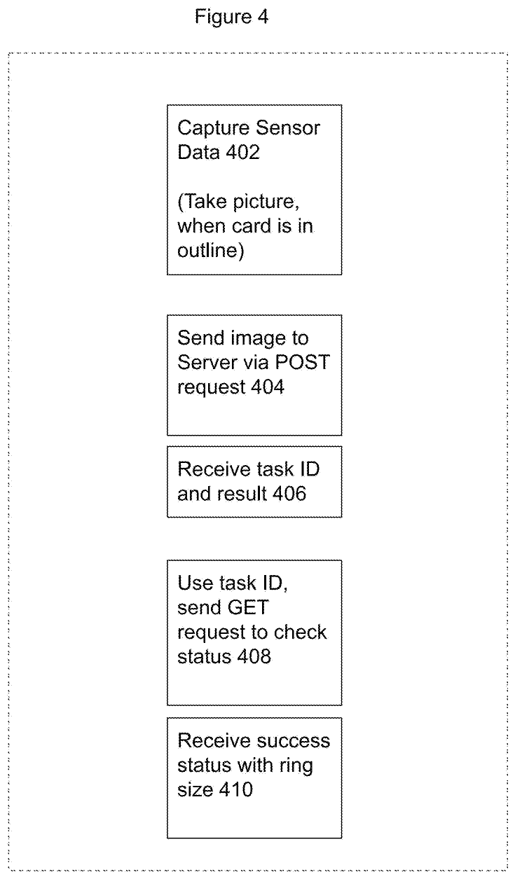

FIG. 4 shows the client side process. In act 402, the sensor data is captured. Then, in act 404, the client sets up a task to be performed at the server, it sends an image to the server via the POST request. In act 406, the client receives the server's response which includes a Task ID, and the result. In act 408, the client uses the Task ID, and sends a GET request to check the latest status. The client may need to send an image (act 404) and check the status (408) a number of times before the server can provide a favorable outcome. Finally, at act 410, the client receives a success status with the ring size in millimeters.

It is possible that the process can be diverted to allow for a manual adjustment or determination of ring size based upon the available data, or for diversion to a more sophisticated ring size determination algorithm. The user may be requested to provide additional lighting. In addition, the phone can be operated to provide additional lighting.

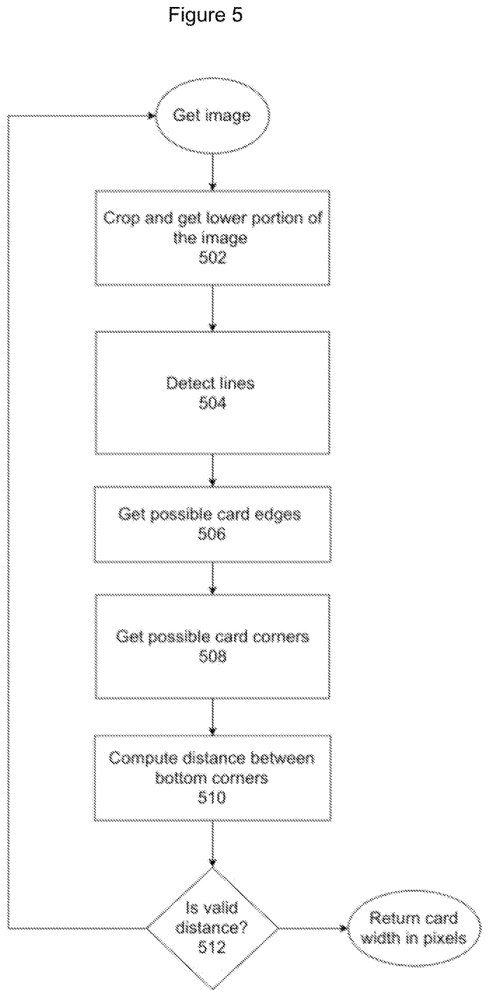

FIG. 5 provides a flow chart showing card size processing 500 in accordance with one embodiment. In an initial act 502, the image is cropped to separate the card and finger portions. It is assumed that the on-screen template is followed, therefore, the portion of the fingers and card can be cropped accordingly. Next, at act 504, line detection is applied on the different color channels of the image. For each channel, the median of the pixel intensities is computed. Canny edge detection is then applied and Hough Transform is used to get the lines based on the edges detected. In act 506, the four longest lines are taken as the edges of the card. In act 508, the corners of the card are determined from line intersections of the edges. At act 510, the distances between the horizontal lines are computed. The algorithm favors the distance along the bottom edge of the card. The measurement is then validated in act 512. If the distance is valid, the card width in pixels is returned, else correction or failure processing are performed. For example, an error message may be provided to the user, prompting the user to change lighting, change the credit card used as a reference object, or perform some other adjustments in order to obtain a new image.

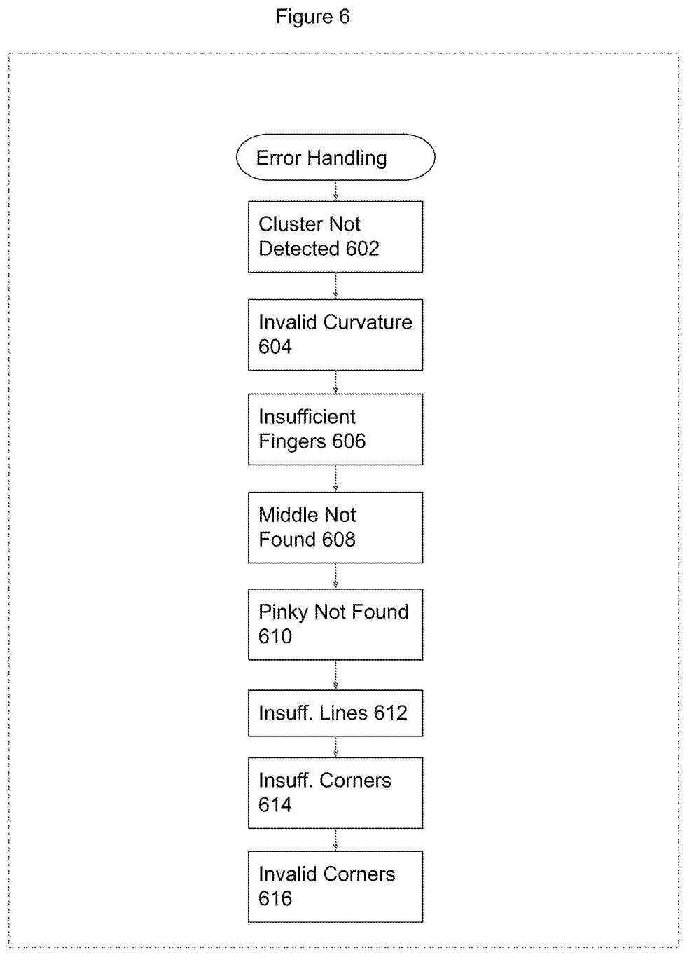

FIG. 6 provides a flowchart showing error handling processing 600. As shown in FIG. 6, this processing includes processing for determining if a cluster was not detected 602 determining if an invalid curvature pattern was detected 604, and determining if an insufficient number of fingers was detected at step 606. In addition, processes may be provided for determining when a middle ring finger was not found at act 608, and when a ring pinky finger was not found at act 610. Processing may also be provided for determining when there were not enough lines in the reference object at act 612, determining when there were not enough corners at act 614, and determining when the corners were deemed invalid at act 616. In each of these processing acts, log messages may be provided, and corresponding messages may be provided for viewing by the user. Example log messages are as follows:

Clusters: could not detect fingers

Curvatures did not follow pattern

Insufficient fingers detected

Middle ring finger point cannot be found.

Ring Pinkie finger point cannot be found.

Not enough valid lines found.

Not enough valid corners found.

Invalid corners: Corners not less than 4.

The following example messages may be provided to the user:

Cannot detect hand, Kindly use a cluttered desk free background.

Kindly follow the hand outline on the screen. Make sure you have a clutter-free background and no shadows.

All fingers are detected. Make sure that the spaces between fingers are not covered by the card.

Space between the middle and ring fingers cannot be found. Make sure that the spaces between your fingers are not covered by the card.

The space between the ring and pinky finger point cannot be found. Make sure that the spaces between your fingers are not covered by the card.

Cannot see lines.

Cannot see Corners.

Invalid corners.

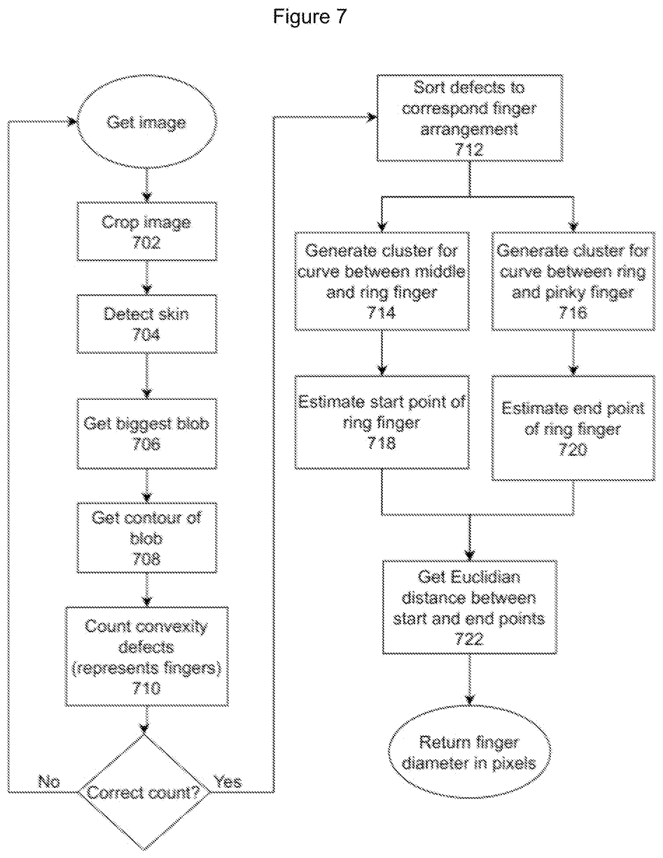

FIG. 7 provides a flowchart of a process for determining a finger diameter. At act 702, the image is cropped so that the general area of the fingers and card are separated. At next act 704, skin detection is applied on the cropped image. With this, at act 706, the biggest blob can be extracted and assumed to be the representation of the hand. The contour of this blob is then generated at act 708. The convexity defects can then be counted from this contour at act 710. These defects represent the fingers in the image. The defects are then counted to verify that they are indeed representatives of the fingers. When the count is wrong, the image is discarded, a new image is taken, and the process starts over at act 702. When the count is correct, it proceeds to act 712 where the defects are then sorted to correspond to finger arrangement of thumb to pinky finger. Next, clusters for the curve between the middle finger and ring finger, and curve between middle finger and pinky finger are generated in act 714 and 716. Through these clusters, the start and end point of the ring finger are estimated in act 718 and 720 respectively. Finally, the distance between these points is computed in act 722 and returns the estimated finger diameter in pixels.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example may arise from applicants/patentees, and others.

What is claimed is:

1. Apparatus comprising
user apparatus, including a memory system, a processing system, a sensor system, and a user interface including at least one image display and an input user interface, the apparatus performing ring sizing on one or more fingers of a given human hand;
operating at least one sensor of the sensor system, two cents at least a portion of the given hand and an adjacent reference object;
the sensor providing sensor spatial data in terms of the sensor, the spatial data including hand spatial information locating portions of an outer surface of the given hand and further including reference object spatial information locating measurable references on the reference object;
performing transformation processing on at least some of the sensor spatial data in order to determine world spatial data in terms of real-world positioning, the transformation processing using the reference object spatial information in the sensor spatial data;
the processing system determining, from the world spatial data, the diameter of the given finger on the given finger's profile at a ring position near where the giving finger joins at least one adjacent non-thumb finger; and
based on the determined diameter value of the given finger, determining a ring size, and communicating the ring size to the user.

2. The apparatus according to claim 1, we're in the user apparatus comprises a handheld smartphone.

3. The apparatus according to claim 1 wearing the user apparatus comprises a wearable smart device.

4. The apparatus according to claim 1, the sensor system comprises a pixelized camera.

5. The apparatus according to claim 1, we're in the sensor system comprises three cameras.

6. The apparatus According to claim 1, wherein the processor is further configured to cause the user interface prompting a user to put both a reference object and a given hand to be sized into a field of view of at least one sensor of the sensor system.

7. The apparatus according to claim 6, wherein the user is prompted via an audible input.

8. The apparatus according to claim 6, wherein the prompting is via a visible output.

9. The apparatus according to claim 6, wherein the reference object is a credit card.

10. The apparatus according to claim 6, wherein the reference object is a portion of the smartphone used by the user.

11. The apparatus according to claim 6, werein the reference object is one or more sensors on a backside of the smartphone.

12. The apparatus according to claim 6, wherein the reference object is an object of known dimensions.

13. The apparatus according to claim 6, further comprising a processing circuit configured to check if an object sensed along with the given hand is likely a standard credit card.

14. The apparatus according to claim 6, wherein the credit card is detected using a rectangle detection request provided as part of the Apple Vision framework.

15. The apparatus according to claim 6, further comprising isolating the outline of the credit card from the rest of the image, and, if part of the credit card is hidden, restoring those aspects of the credit card in the image.

16. The apparatus according to claim 6, wherein the processor is configured to further cause confirming whether a given finger of the hand to be sized and the reference object are substantially in the same plane and at substantially the same distance from the lens of the camera.

17. The apparatus according to claim 1, wherein the sensor spatial data is provided automatically once the reference object and the given hand are sensed by one or more sensors to be in the field of view of the at least one sensor locating the given hand.

18. The apparatus according to claim 1, wherein the sensor spatial data is provided responsive to prompting by the user via the user interface.

19. A method comprising comprising
operating at least one sensor of a sensor system provided as part of user apparatus, to sense at least a portion of a given hand and an adjacent reference object, the user apparatus including a memory system, a processing system, the sensor system, and a user interface;
the sensor providing sensor spatial data in terms of the sensor, the sensor spatial data including hand spatial information locating portions of an outer surface of the given hand and further including reference object spatial information locating measurable references on the reference object;
performing transformation processing on at least some of the sensor spatial data in order to determine world spatial data in terms of real-world positioning, the transformation processing using the reference object spatial information in the sensor spatial data;
the processing system determining, from the world spatial data, the diameter of the given finger on the given finger's profile at a ring position near where the giving finger joins at least one adjacent non-thumb finger; and
based on the determined diameter value of the given finger, determining a ring size, and communicating the ring size to the user.

20. Machine-readable media encoded with non-transitory machine-readable data configured to, when read by a machine, cause:
operating at least one sensor of a sensor system provided as part of user apparatus, to sense at least a portion of a given hand and an adjacent reference object, the user apparatus including a memory system, a processing system, the sensor system, and a user interface;
the sensor providing sensor spatial data in terms of the sensor, the sensor spatial data including hand spatial information locating portions of an outer surface of the given hand and further including reference object spatial information locating measurable references on the reference object;
performing transformation processing on at least some of the sensor spatial data in order to determine world spatial data in terms of real-world positioning, the transformation processing using the reference object spatial information in the sensor spatial data;
the processing system determining, from the world spatial data, the diameter of the given finger on the given finger's profile at a ring position near where the giving finger joins at least one adjacent non-thumb finger; and
based on the determined diameter value of the given finger, determining a ring size, and communicating the ring size to the user.
